(19) United States
(12) Patent Application Publication
(10) Pub. No.: US 2005/0103537 A1
(43) Pub. Date: May 19, 2005

(54) Propuision and recharge system for an electric vehicle with a propeller system

(76) Inventors: Laurent Michaud, Montreal (CA); Denis Blanchette, Montreal (CA); Joanne Michaud, Montreal (CA)

Correspondence Address: LAURENT MICHAUD, 8240 LAFERTE, SAINT-LEONARD, QC, H1P-2N9, CA

(21) Appl. No.: 10/645,939

(22) Filed: Aug. 25, 2003

Related U.S. Application Data
(60) Provisional application No. 60/446,980, filed on Feb. 13, 2003.

(30) Foreign Application Priority Data
Sep. 23, 2002 (CA) 2,402,232

(51) Int. Cl. B60L 8/00; B60K 1/00

(52) U.S. Cl. 180/2.2; 180/65.1

(57) ABSTRACT

Wind turns propellers, which in them generate enough energy to be used in an electric vehicle.

### CROSS-REFERENCE TO RELATED APPLICATION

60/446,980 Feb. 13, 2003.

### STATEMENT REGARDING FEDERALLY SPONSORED RESEARCH OF DEVELOPMENT

Not Applicable.

### REFERENCE TO SEQUENCE LISTING

Not Applicable.

### BACKGROUND OF THE INVENTION

Automobile, Propulsion, Energy, Electric Car

This generator should be installed to replace conventional engines, which will be activated by the propellers. Other parts needed for an electric vehicle are engines installed in Wheels, Hydro Quebec aid make these engine but are now working on more powerful battery's for electric vehicles.

### BRIEF SUMMARY OF THE INVENTION

A propeller system mounted in front of an electric vehicle (automobile) as to provide electric power to a generator. To recharge electric vehicle batteries and or be in use to provide electricity for a generator to provide propulsion to the vehicle.

### BRIEF DESCRIPTION OF THE SEVERAL VIEWS OF THE DRAWING

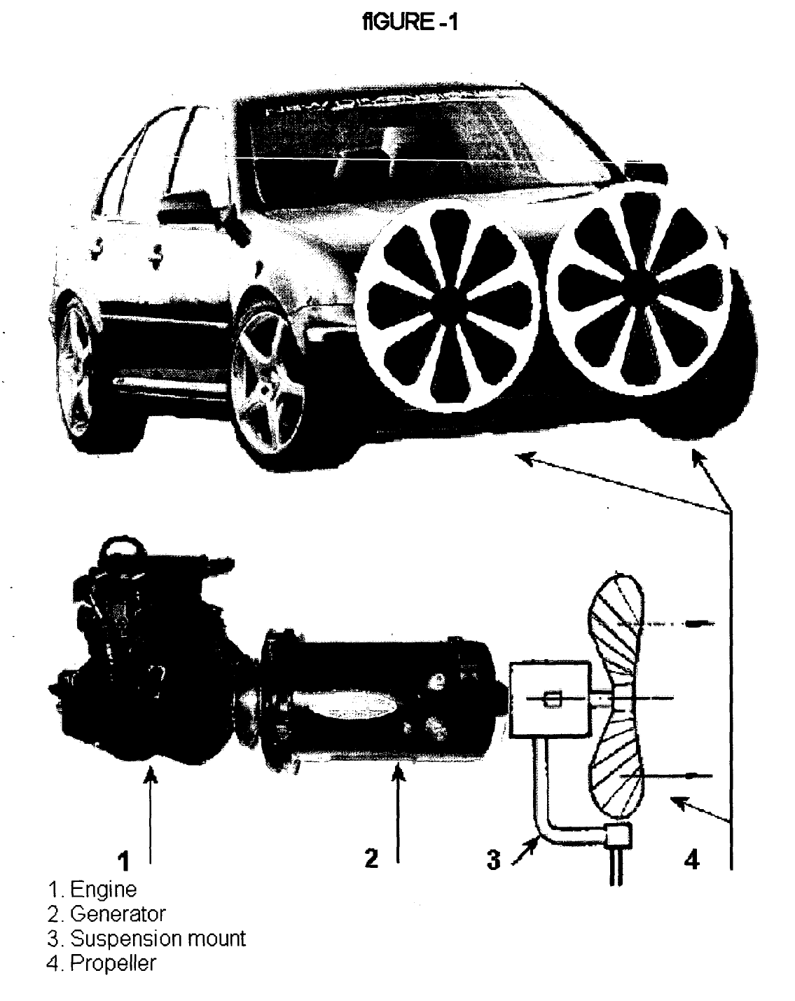

FIG. 1 shows a one propeller system, alternator, voltage box and battery mounted in front of a vehicle.
1. Battery
2. Voltage Box
3. Alternator
4. Installs on suspension support
5. Guide to keep ar from escaping
6. Propeller shaft
7. Propeller

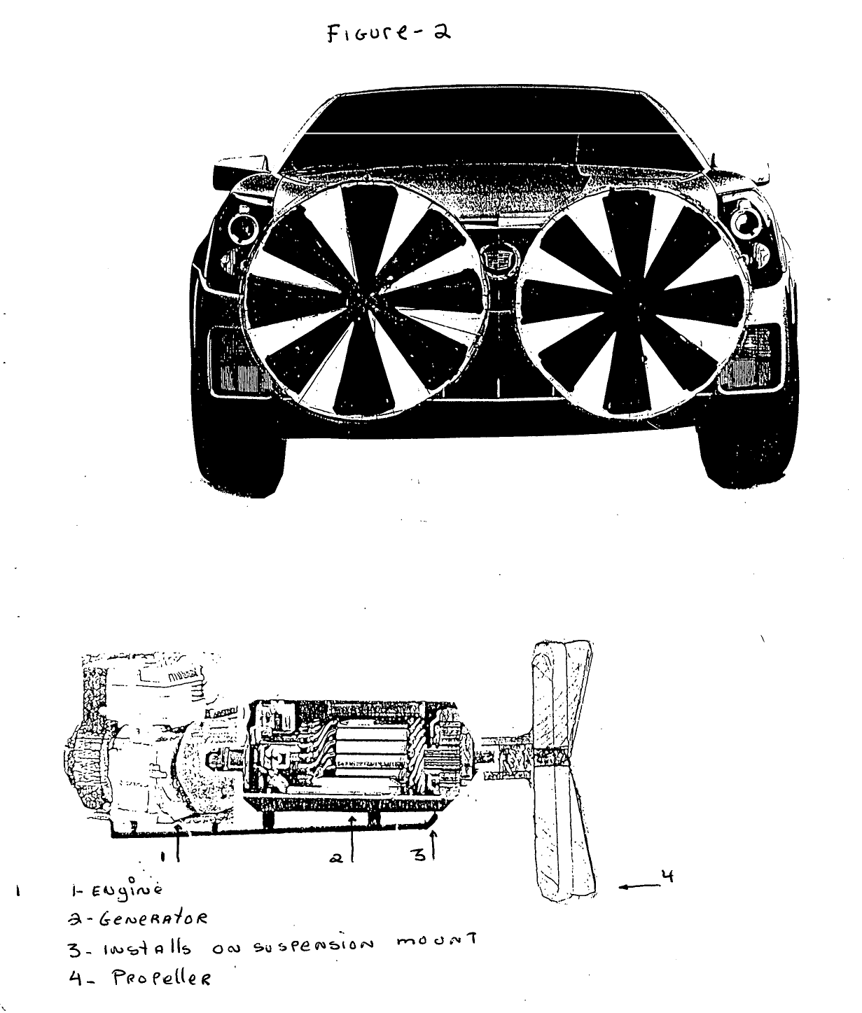

FIG. 2 Shows two propellers system, generator and 2 cyl. Engine
1. 2 cylinder. Engine
2. Generator
3. Suspension support
4. Propeller

### DETAILED DESCRIPTION OF THE INVENTION

The generator replaces a conventional combustion engine, which will be activated by the propellers. Electric vehicles use batteries to provide power to the generator. Therefore a propeller system could be in use to replace these batteries in conjunction with a 2 cylinder propane gas engine to activate the generator at 40 Km/Hrs the propellers received enough pressure to activate the generator and the propane engine stops. For urban use where a speed of less than 40 Km/Hrs the wind pressure will be less and therefore the gasoline engine would be required to provide power to the generator.

The creative idea of this invention is to provide less expense and help reduce pollution made by conventional engines to help save our planet.

1. What I claim as my invention is a propeller system. The idea of propellers used in a given vehicle to provide power to a generator or alternator for a propulsion system.
